(19) United States
(12) Patent Application Publication
(10) Pub. No.: US 2002/0043732 A1
(43) Pub. Date: Apr. 18, 2002

(54) Apparatus, kit and method for repairing a surface break in selected surfaces of an transparent object

(76) Inventors: Gerald Jacino, Kew Gardens, NY (US); Anthony Jacino, East Moriches, NY (US)

Correspondence Address: M. Arthur Auslander, Esq., Auslander & Thomas, 505 Eighth Avenue, New York, NY, 10018-6505, US

(21) Appl. No.: 09/927,087

(22) Filed: Aug. 9, 2001

Related U.S. Application Data
(60) Provisional application No. 60/224,484, filed on Aug. 11, 2000.

(51) Int. Cl. B29C 73/02

(52) U.S. Cl. 264/36.1; 264/36.21; 425/12; 425/13

(57) ABSTRACT

The present invention is a new resin chamber construction, a kit and method for the repair of large selection of breaks in a lens or an automobile light bulb housing and even plate glass. The kit and method enable an inexpensive in situ repair including a bead overriding the break substantially maintaining light diffusions patterns. The bead forms an environmentally impervious repair which can match the color of the housing or lens including a substantially matching light diffusion pattern to diffuse light substantially similar to that of the unbroken article. The kit includes parts enclosable in a blister pack. The blister cover may include a resin chamber construction which can be cut out from it.

### BACKGROUND OF THE INVENTION

The present invention relates to a resin chamber construction, kit and method for repairing a selected break from the surface, of a transparent automobile light bulb housing, an automobile light lens, or a plate of glass or plastic.

The repair of plate glass and automobile light housings whether lenses or housings and plate glass is complex, expensive and frought with permutations and combinations of physical and visual problems. A spectrum of the situations can be found in Jacino U.S. Pat. Nos. 4,200,478, 4,961,883, 5,209,935, 5,401,152, 6,074,852 and PCT Application PCT/US99/25472, all incorporated by reference.

The present invention including a new resin chamber construction, enables a new ability for the repair of plate glass and automobile light housings whether lenses or housings and plate glass. The repair is effected on a surface and adapts to the provision of grid patterns and color.

Another unexpected aspect of the present invention is that the repair can be effected in situ without physical removal of the repaired object such as a lightbulb housing, lens or pane of plate glass.

### DESCRIPTION OF THE RELATED ART

In the past, automobile light bulb housings lenses have been repaired by covering the housings with tape just to protect them from the atmosphere.

The tape has been either opaque or translucent. Tapes used in such repair have even been selected to match the color of the broken part of the lens. To repair voids, repairs have been made by the flush filling of the broken spaces; plastic castings were also made to fill breaks. Many different techniques were used.

U.S. Pat. No. 4,497,755 discloses a kit for the repair of automobile light bulb housing lenses by casting the repair. The repair method includes the use of flush tapes to form a releasable form for molding an exothermic adhesive resin to make a repair. Colored resin was used to match colors in the automobile plastic light bulb housing and glass bead were used to simulate the facets in the broken diffuse area.

As shown in U.S. Pat. No. 5,401,157, breaks through glass have been repaired by providing a gasket with a cover to form a mold for a casting including a bead surrounding a repaired area. The gasket and cover define the shape of the repair casting.

U.S. Pat. No. 4,200,478 discloses a pedestal adapted to create a casting to override and surround a break in glass.

U.S. Pat. No. 3,887,413 discloses a method for repairing plastic materials, using an insert backing material, protective paste and graining paper and uses a hot surface, such as iron. See FIG. 1. A flat backing material is used to hold the heat responsive elastic repair material flush with the surface of the patched area.

U.S. Pat. No. 3,772,114 discloses a process for mending fabrics, including the use of an adhesive which contains a color additive to match the area around the repair. The invention is involved with fitting in a flush patch supported on one side.

U.S. Pat. No. 3,388,016 discloses a method and apparatus for patching articles. The method and apparatus are a complex set to apply a fiber glass patch to one surface. Flush liners may be used.

U.S. Pat. No. 3,109,765 discloses a method for repairing surfaces, wherein a textured backing is used. A textured backing hold holds a composition applied from an outer surface of a rupture.

U.S. Pat. No. 4,961,883 discloses a pedestal and a seal surrounding an opening and forming a chamber for the introduction of a repair plastic, forming an irregular bead, which has to be cut off flush. The bead is formed in the central opening 20.

U.S. Pat. No. 4,473,419 discloses the use of a flush patch to a contoured surface for the purpose of making a repair.

U.S. Pat. No. 3,138,505 discloses means for mending fabric, using a heat responsive thermoplastic adhesive backed by a substrate which may be stripped, then bonding a matching patch to the fabric and the adhesive. The patch is ironed on.

U.S. Pat. No. 3,841,932 discloses a surface patch for windshield glass, which leaves a superficial dam which is removed.

U.S. Pat. No. 3,914,145 discloses a flush patch casting for the repair of plate glass.

U.S. Pat. No. 4,147,576 is a substantially invisible PVC auto body non transparent repair over a damaged area.

U.S. Pat. No. 4,094,316 is a decorative applique overlay adherable to bandage.

U.S. Pat. No. 4,588,619 is a reflective panel for diffusion of light in an automotive lens housing.

U.S. Pat. No. 4,221,465 is a patching tape to alter the light transmissive characteristics of a view graph.

U.S. Pat. No. 4,661,182 is a non transparent substantially invisible surface repair of the damaged glossy surface of an auto body.

U.S. Pat. No. 2,833,327 is a laminated tire patch with an adhesive layer.

U.S. Pat. No. 3,939,337 is an elastomeric gasket for a light housing assembly for mounting a lens.

### SUMMARY OF THE INVENTION

According to the present invention, a resin chamber construction, and a kit and method are provided for repairing for repairing a break from a selected surface, particularly a transparent surface such as the lens of an automobile light bulb housing, an automobile light lens, a plate of glass or plastic, in situ substantially maintaining the selected light diffusion characteristics of the original article.

The resin chamber is the enablement when used with a cover to seal a surface break. The resin chamber construction includes, the chamber, a flange portion, to be sealed around the break, at least one air vent and a pouring spout.

In its simplest form, a repair can be performed with a cover sealing the outer surface of the break and the chamber portion of the resin chamber construction sealed, spaced away from the sealing cover and surrounding its outer periphery.

The kit includes the resin chamber construction, sealing cover, a peripheral adhesive sealing gasket, a push pin and a resin container. The kit is preferably mounted on a display card with blister pack. In other variations the kit may include a selection of pigment colors.

The resin chamber construction can be an integral part of an enclosing blister on the kit package. The resin chamber construction can also include a diffusion pattern to match the pattern of the lens or housing repaired.

The method includes the steps of sealing a break with a sealing cover, selecting a resin chamber construction to form a mold for the resin that effects the repair, filling the resin into the resin chamber construction. It is important for the resin chamber construction to extend beyond the periphery of the cover over the break. A sealing gasket may be used for convenience, particularly when the resin chamber construction is an integral part of the kit blister pack, and it is cut out of the blister for use.

### BRIEF DESCRIPTION OF THE DRAWING

Although such novel feature or features believed to be characteristic of the invention are pointed out in the claims, the invention and the manner in which it may be carried out may be further understood by reference to the description following and the accompanying drawings.

FIG. 1 is a plan view of the resin chamber construction of the present invention.

FIG. 2 is a top view of FIG. 1.

FIG. 3 is a left side view of FIG. 1

FIG. 4 is a detail showing a front elevation of a bullseye break in a glass headlight housing.

FIG. 5 is a detail view of the bulls eye break as shown in FIG. 4 overlain with a transparent adhering cover.

FIG. 6 is a detail section of FIG. 5 at lines 6-6.

FIG. 7 Is a detail of a headlight repair with a resin chamber construction of the present invention engaged over the transparent adhering cover of FIG. 6 and filled with resin.

FIG. 8 shows the molded bead formed in FIG. 7 with the resin chamber construction removed.

FIG. 9 is a section of FIG. 8 at lines 9-9 showing the completed repair.

FIG. 10 is a section of an alternate repair configuration particularly for use with plate glass.

FIGS. 11-17 are the elements of a kit of the present invention for repairing a break in a headlight housing or a lens.

FIG. 11, is an isometric view of a resin chamber construction including a grid pattern molded into the resin chamber.

FIG. 12 is a front elevation of a gasket for use with the resin chamber construction of FIG. 11.

FIG. 13 is a detail schematic right side elevation of the gasket of FIG. 12.

FIG. 14 is a cover for the sealing of the outer opening of a break through the transparent surface particularly of a lens or a glass bulb housing, shown mounted on a release sheet.

FIG. 15 is a detail schematic right side elevation of FIG. 14.

FIG. 16 is a push pin for a kit of the present invention.

FIG. 17 is a resin container for a kit of the present invention.

FIG. 18 is a blister pack kit of the present invention mounted on a cut away display card including all the elements shown in FIGS. 11-17.

FIGS. 19-26 are the elements of another kit of the present invention.

FIG. 19 is another embodiment of a resin chamber construction of the present invention including a grid pattern.

FIG. 20 is a right side elevation of a FIG. 19.

FIG. 21 is a cover for the sealing of the opening of a break through a transparent surface, mounted on a release sheet.

FIG. 22 is a right side elevation of a FIG. 21.

FIG. 23 is a front elevation of gasket for use with the resin chamber construction of FIG. 19.

FIG. 24 is a right side elevation of a FIG. 23.

FIG. 25 is a pair of syringes for a selected sealing resin for a repair of the present invention.

FIG. 26 is a pair of syringes for selected pigments for the sealing resin of the present invention.

FIG. 27 shows the mounting of the cover of FIG. 21 over a break to be repaired.

FIG. 28 shows cutting the cover to remove the excess.

FIG. 29 shows the placing of the gasket of FIG. 24 around the cover.

FIG. 30 shows mounting the resin chamber construction on the mounted gasket of FIG. 29.

FIG. 31 shows the filling of a syringe from a mixing receptacle.

FIG. 32 shows the injection of the resin into the resin chamber construction of FIG. 19.

### DESCRIPTION OF THE PREFERRED EMBODIMENT

Referring now to the figures in greater detail, where like reference numbers denote like parts in the various figures.

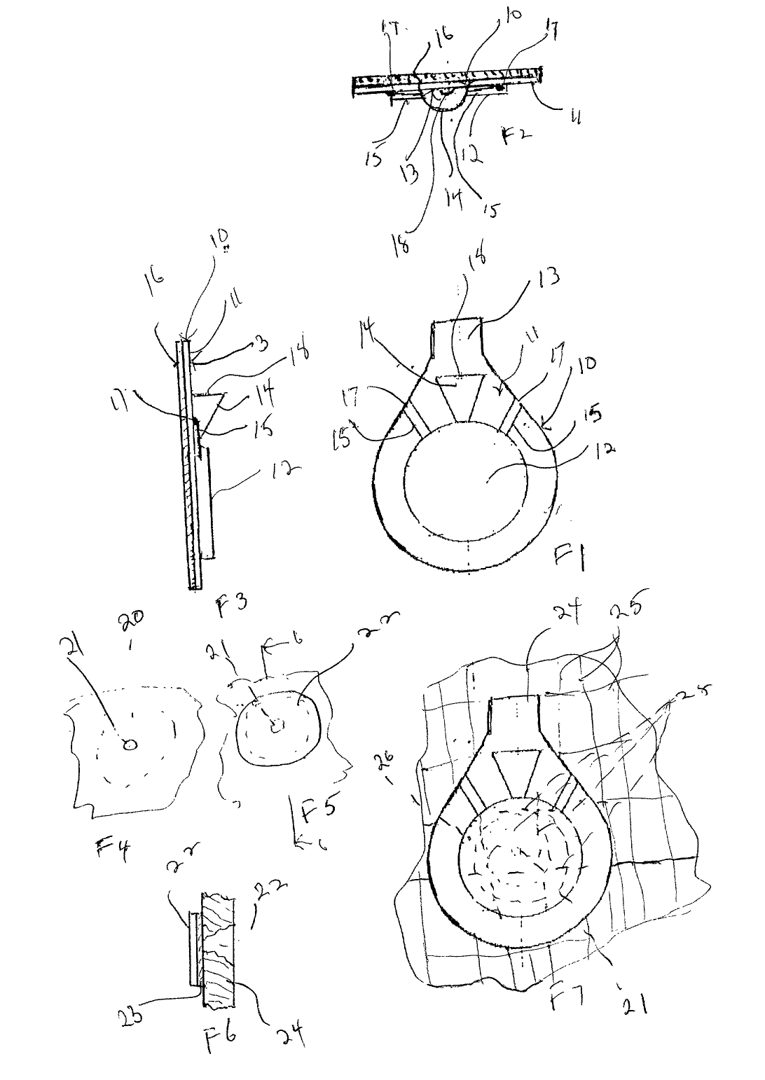

The resin chamber construction 10 as shown in FIG. 1 comprises an integral peripheral flange portion 11, a resin chamber 12, a flange portion 11, a tab 13, a pouring spout 14 and at least one vent 15. The flange portion 11 includes an adhesive layer 16.

At least the resin chamber 12 is preferably transparent. As shown in FIG. 1, the resin chamber construction 10 is a unitary molded transparent plastic. The vents 15 and pouring spout 14 open into the resin chamber 12. The vents 15 have openings 17 to the atmosphere. The pouring spout 14 has an opening 18 open to the atmosphere.

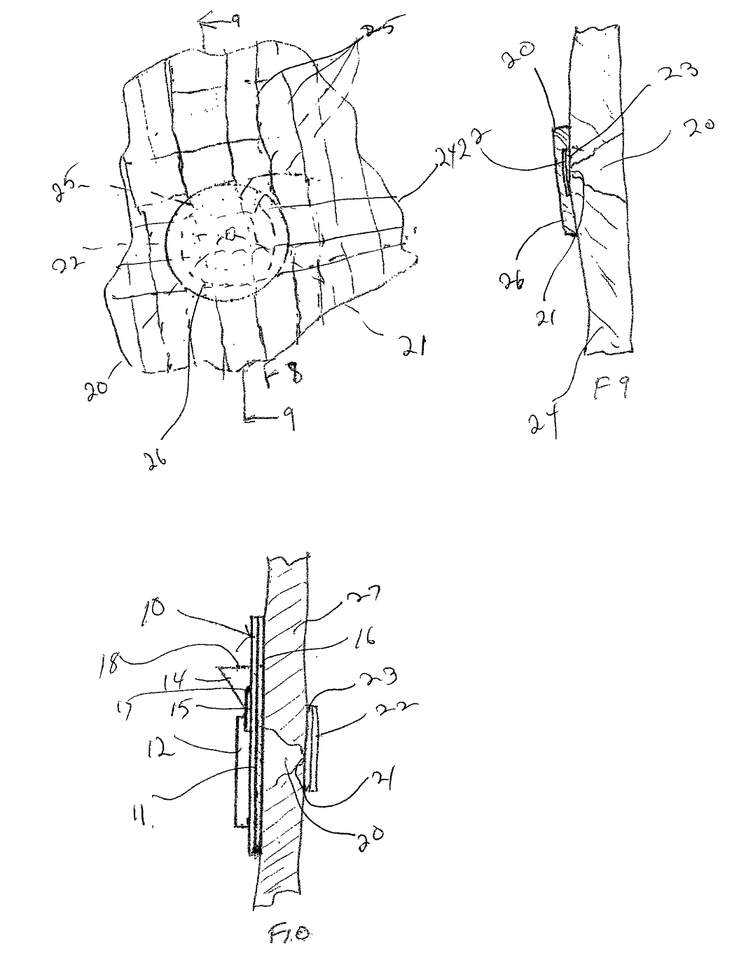

As shown in the detail in FIGS. 4-9, a bulls eye break 20, particularly as in a glass bulb housing for and automobile (not shown) has a surface pit 21. In making a repair of the bulls eye break 20 a cover 22 with an adhesive back 23 is engaged over the pit 21 as shown in FIGS. 6-9.

The resin chamber construction 10 is engaged over the pit 21 with the cover 22 in place. The adhesive layer 16 holds the resin chamber construction 10 in place so that a selected resin, well known in the art, can be pour or injected into the resin chamber 12, where it cures or is cured by means well known in the art. The resin is poured or injected through the opening 18 in the pouring spout 14. Air and/or bubbles escape through the vents 15, through the openings 17. The resin chamber 12 is selected to have a depth to allow the formation of a bead 26 of sufficient thickness to protect the light bulb housing 24 and allow light to pass through the bead 26 and the cover 22 with a minimum of attenuation.

As shown in FIGS. 7 and 8, the light diffusion pattern lines 25 of the unbroken portion of the light bulb housing 24 show through the repair with a minimum of attenuation. As shown in FIG. 8 with the resin chamber construction 10 removed, the bead 26, though extending beyond the outer surface of the light bulb housing 24, substantially maintains the appearance of the light bulb housing 24.

As shown in FIG. 9, the bulls eye break 20 does not have to be filled in order to restore the light bulb housing 24 to usability. The cover 22 with the adhesive back 23 are all contained within the bead 26.

The resin chamber construction 10 is a great advance in the art. It enables an effective repair of a light bulb housing 24 break or lens break, without the difficult task of having to remove it.

The integral pouring spout 14, opening into the resin chamber 12 and to the atmosphere, from outside the resin chamber construction 10 and the vents 15 opening into the resin chamber 12, openings 17 opening to the atmosphere, enable the repair.

The method includes adhering a cover 22 over the pit 21 or over any open break with an appropriate sized cover, emplacing a resin chamber construction 10 and molding a resin over the surface of the broken object. This repairs the break and maximizes the normal light diffusion.

As shown in FIG. 10, the resin chamber construction 10 also can be used for an effective in situ repair of a plate of glass 27. The cover 22 is applied at the pit 21 only on the outside portion of the plate of glass 27. The resin chamber construction 10 is engaged on the inside of the plate of glass 27. The resin is conventionally used, in this instance the entire break or bulls eye break 20 is filled with the resin.

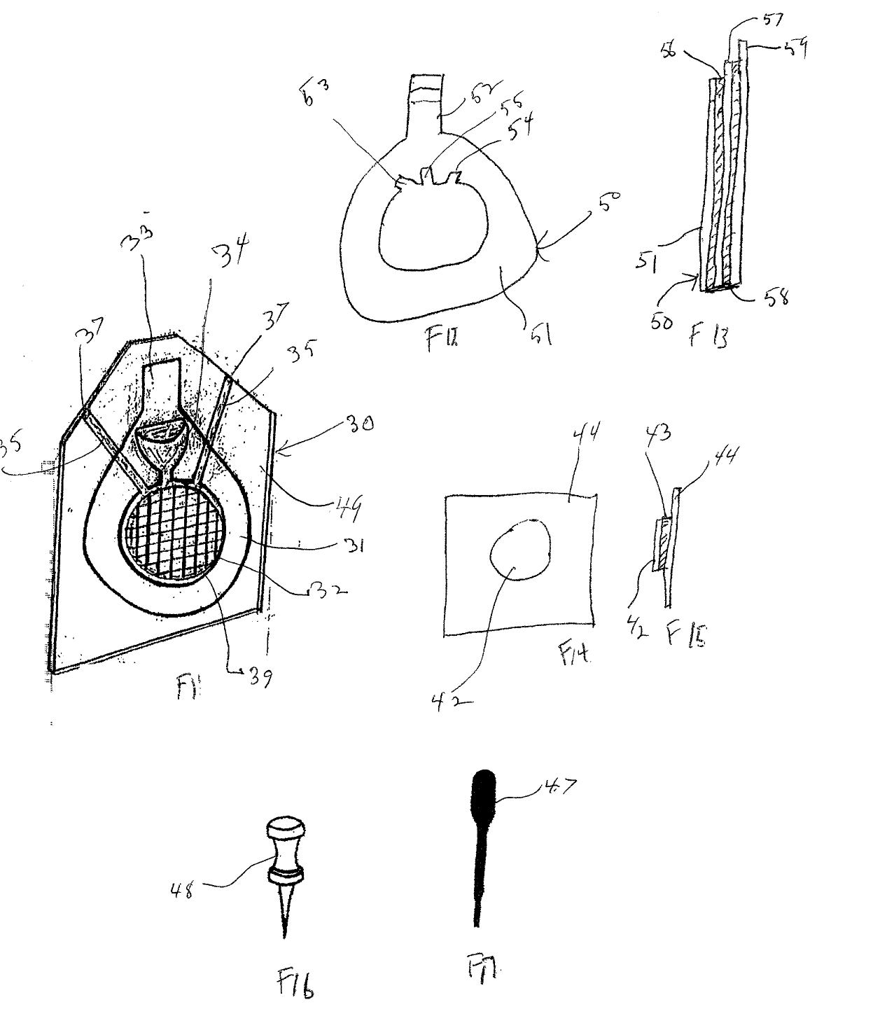

FIGS. 11-18 show the parts of a kit for the repair of breaks in transparent automobile light bulb housings and lens.

FIG. 11 shows a resin chamber construction 30. The resin chamber construction 30 is part of a plastic base 49 which includes a peripheral flange portion 31, a resin chamber 32, a tab 33, a pouring spout 34, vents 35, vent opening 37, and a grid pattern 39.

FIGS. 12 and 13 show the gasket 50 with a release cover 51, tab portion 52, vent inset 53, vent inset 54, pouring spout inset 55, adhesive layer 56, working gasket 57, adhesive layer 58 and release paper 59.

FIGS. 14 and 15 show the cover 42 with a adhesive back 43 and a release sheet 44.

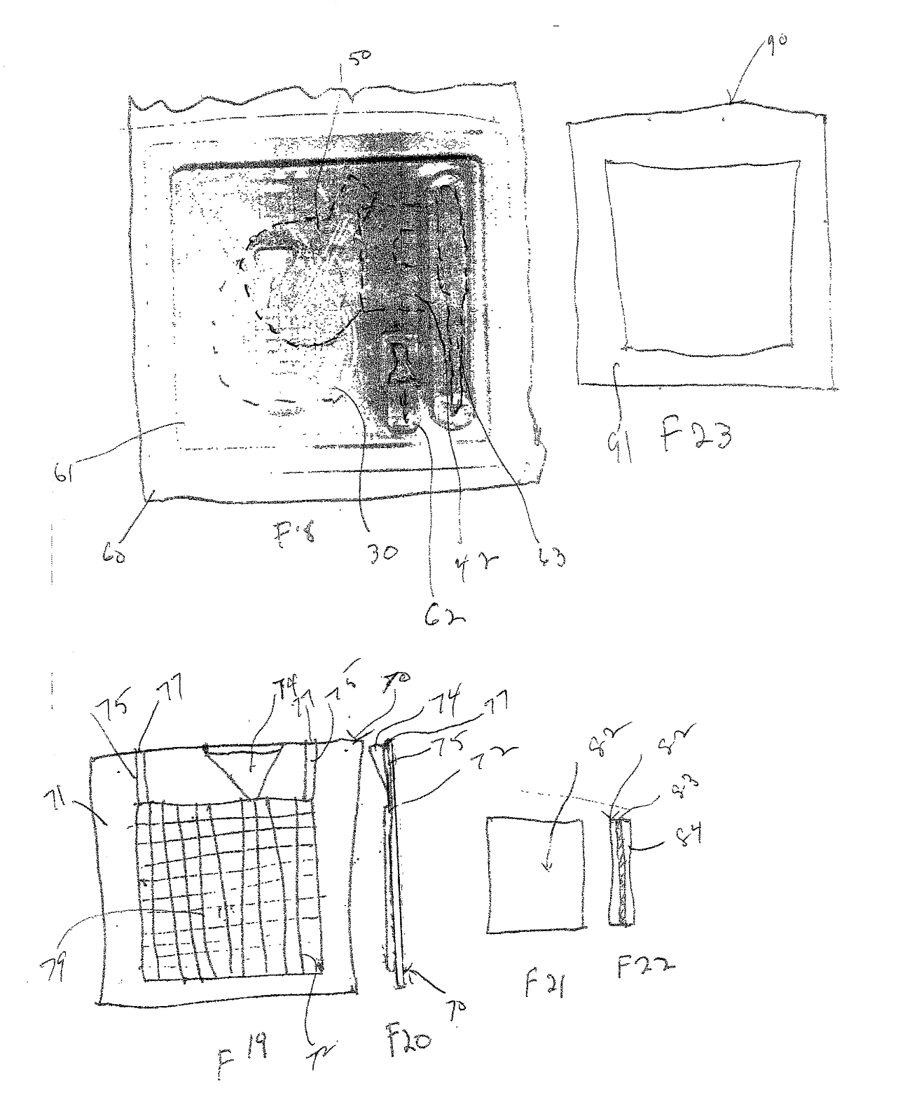

FIGS. 16 and 17 show a push pin 48 and resin container 47.

FIG. 18 shows a cut away of a kit of the present invention mounted on a display card 60 with a blister cover 61. The blister cover 61 includes a push pin blister 62 and a resin container blister 63 to contain the respective push pin 48 and resin container 47. The blister cover 61 includes an integral impression of the resin chamber construction 30 which is shown cut out of the blister cover 61 in FIG. 11.

Shown within the blister cover 61 are the gasket 50, cover 42, push pin 48, and resin container 47.

The resin chamber construction 30 is physically cut out of the blister cover 61 as shown in FIG. 11. peripheral flange portion 31 is shallower than the resin chamber construction 10 and includes a grid pattern 39 for light diffusion.

In the method of making a repair the cover 42 has its release sheet 44 removed. The cover 42 is then placed over the break. The resin chamber construction 30 can be selected to match the diffusion pattern of the broken lens. The gasket 50 has the release paper 59 removed and is placed around the break and the cover 42, with the adhesive layer 58 adhering to the surface of the lens or glass to be repaired with the tab portion 52 substantially vertical. The release cover 51 is then removed and resin chamber construction 30 is then engaged over the gasket 50 and adhered to the adhesive layer 56.

The vents 35 must be aligned with the vent inset 53 and vent inset 54 and the pouring spout 34 aligned with the pouring spout inset 55. The push pin 48 is then used to puncture the pouring spout 34. The push pin 48 is also used to puncture the resin container 47. Resin from the resin container 47 is the put into the pouring spout 34 at the puncture to fill the resin chamber 32.

In the event the openings 37 are not exposed the push pin 48 can be used to open the vents 35. The repair is substantially identical to the repair as shown in FIGS. 7-9 with the thickness of the bead 26 defined by the thickness of the resin chamber 32 and of the working gasket 57.

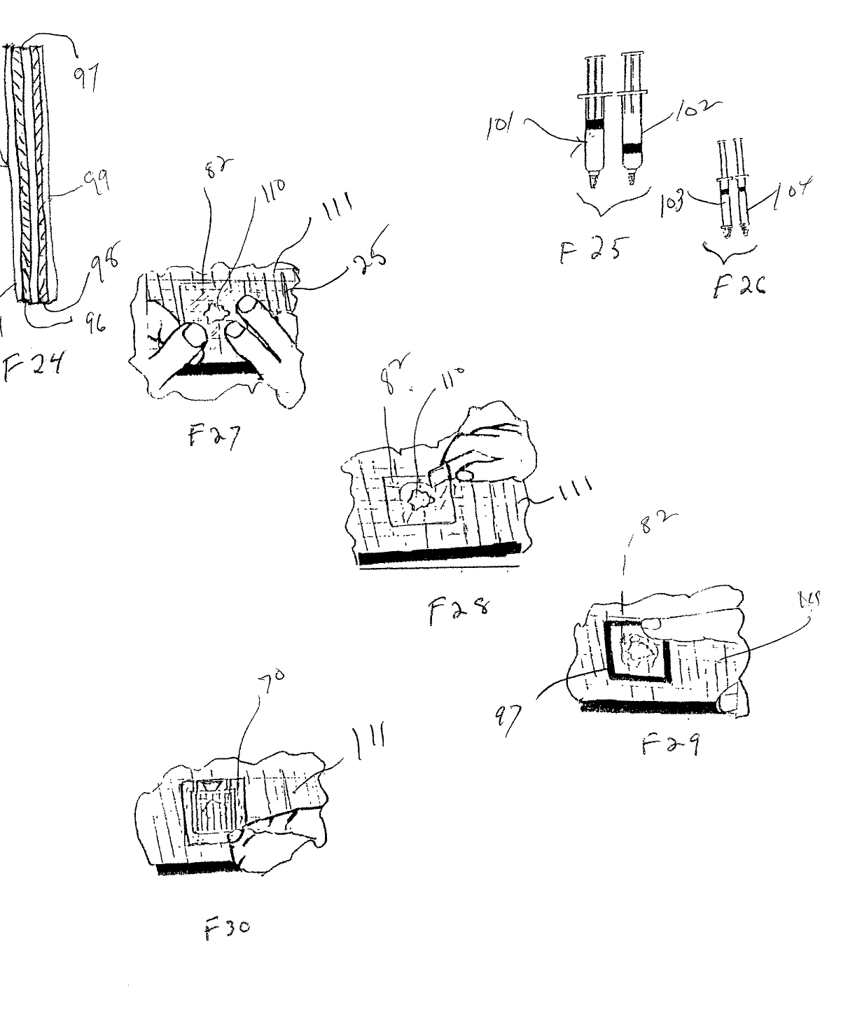

As shown in FIG. 19-24 another resin chamber construction 70 has a flange portion 71, resin chamber 72, pouring spout 74, vents 75, openings 77, and a grid pattern 79. The shape and contour is shown in FIG. 20. There is a cover 82 with an adhesive back 83 and a release sheet 84. A gasket 90, as shown in FIG. 24, has a cover 91, a adhesive layer 96, a working gasket 97, an adhesive layer 98 and a release paper 99. As part of a kit a FIG. 25 shows a pair of syringes, syringe 101 for resin and syringe 102 for hardener. In FIG. 26 a pair of syringes are shown for pigment. Syringe 103 for red and syringe 104 for amber.

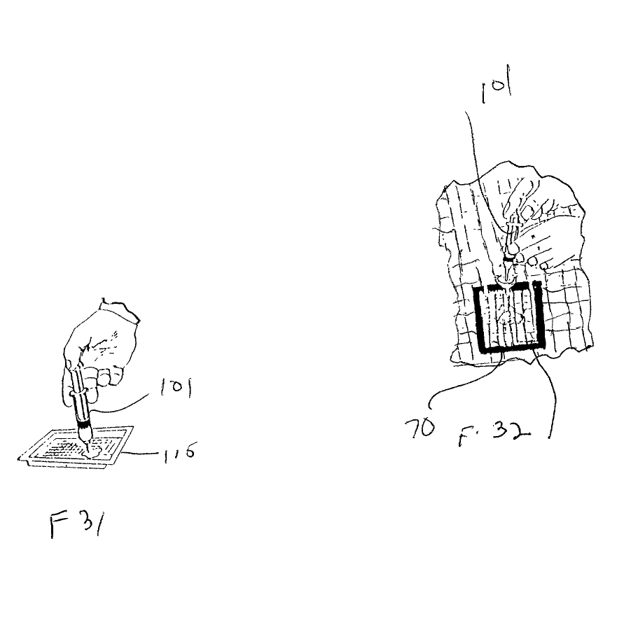

As shown in FIG. 27, a transparent cover 82 with release sheet 84 removed is adhered over a ragged break 110 in a light bulb housing 111. As shown in FIG. 28, the cover 82 is trimmed to overlap the break 110. As shown in FIG. 29, the working gasket 97 is affixed to the light bulb housing 111 surrounding the trimmed cover 82. As shown in FIG. 30, the resin chamber construction 70 is engaged on the working gasket 97 (not shown). As shown in FIG. 31 the resin is mixed, as is well known in the art, optionally including a selected pigment and withdrawn into a syringe 101. As shown in FIG. 32, the resin is injected into the pouring spout 74 to complete the repair. The repair includes a mold of the grid pattern 79, which is selected to simulate the diffusion pattern of the basic lens light bulb housing 111.

The configuration of the resin chamber construction 70 maintains the combination of novel elements of the present invention, the combination of resin chamber construction 70 including a chamber 72 engagable on the outside of a lens or housing, in situ, or even on the inside of plate glass in situ. A basic pouring spout 74 must open to the chamber 72. The chamber 72 must also be vented on the same plane so that the entire repair can be poured and vented from the same side.

The resin chamber construction enables an in situ repair maximizing the security of a housing or of a lens. The resin chamber construction of the present invention also facilitates an improved repair of plate glass.

The terms and expressions which are employed are used as terms of description; it is recognized, though, that various modifications are possible.

It is also understood the following claims are intended to cover all of the generic and specific features of the invention herein described; and all statements of the scope of the invention which as a matter of language, might fall therebetween.

Having described certain forms of the invention in some detail, what is claimed is:

1. A unitary resin chamber construction, said construction including a chamber, a peripheral flange, a pouring spout, and at least one vent.

2. The resin chamber construction of claim 1, wherein said peripheral flange includes an inner surface and an outer surface, said inner surface including an adhesive layer.

3. The resin chamber construction of claim 2, including a release cover over said adhesive.

4. The invention of claim 2 wherein said peripheral flange is substantially on a plane, and said chamber extending outward from said plane of said peripheral flange portion without adhesive.

5. The invention of claim 2 wherein said peripheral flange includes a tab.

6. The invention of claim 4 wherein said at least one vent and said pouring spout open into said chamber, said at least one vent and pouring spout in close proximity to each other.

7. The invention of claim 6 wherein said chamber includes an outer surface and said outer surface includes light diffuser means.

8. The invention of claim 7 wherein said chamber is round.

9. The invention of claim 7 wherein said chamber is square.

10. The method of repairing a break in a selected light permeable surface of plastic or glass substantially maintaining light diffusion characteristics of said selected surface including the step of providing a cover, for said break, said cover being transparent and including an adhesive surface, engaging said cover surrounding said break, said cover engaged at said adhesive surface and over said break, providing an integral resin chamber construction, said resin chamber construction including a chamber, a peripheral flange, a pouring spout, and at least one vent, said at least one vent and pouring spout in close proximity to each other, said peripheral flange including an inner surface and an outer surface, said inner surface including an adhesive layer, said peripheral flange substantially on a plane, said chamber extending outward from said plane of said peripheral flange portion without adhesive, said at least one vent and said pouring spout opening into said chamber, said chamber including an outer surface, said outer surface optionally including light diffuser means, said chamber of greater periphery than said cover, engaging said adhesive layer of said flange surrounding and spaced away from said cover, maintaining said integral resin chamber construction with said cover and integral chamber construction with said pouring spout above horizontal, introducing a selected curable resin through said pouring spout, curing said resin, forming a bead molded inside said chamber over said break and extending over said cover, and removing said resin chamber construction.

11. The method of repairing a bulls eye break through plate glass substantially maintaining transparency characteristics of said plate glass, said break including an opening and a pit, including the step of providing a cover over said pit, said cover and including an adhesive surface, engaging said cover surrounding said pit, said cover engaged at said adhesive surface and over said pit, providing an integral resin chamber construction, said resin chamber construction including a chamber; a peripheral flange; a pouring spout, and at least one vent, said at least one vent and pouring spout in close proximity to each other, said peripheral flange including an inner surface and an outer surface, said inner surface including an adhesive layer, said peripheral flange substantially on a plane, said chamber extending outward from said plane of said peripheral flange portion without adhesive, said at least one vent and said pouring spout opening into said chamber, said chamber including an outer surface, engaging said adhesive layer of said flange surrounding said break, maintaining said integral resin chamber construction with at least said pouring spout and said at least one vent above horizontal, introducing a selected curable resin through said pouring spout, curing said resin, removing said resin chamber construction, and trimming said glass repair surfaces.

12. A kit for repairing a break in a selected light permeable surface of plastic or glass substantially maintaining light diffusion characteristics of said selected surface including a cover, said cover including an adhesive surface mounted on a release sheet, said cover being transparent and including an adhesive surface, said adhesive surface mounted on a release sheet, an integral resin chamber construction, said resin chamber construction including a chamber; a peripheral flange; a pouring spout; at least one vent; said at least one vent and pouring spout in close proximity to each other; said peripheral flange substantially on a plane, said chamber extending outward from said plane of said peripheral flange portion; said at least one vent and said pouring spout opening into said chamber, said chamber including an outer surface, said outer surface optionally including light diffuser means, said chamber of greater periphery than said cover, a gasket; said gasket including at least a first adhesive layer; at least one vent inset; a pouring spout inset; and a second adhesive layer, and at least a sealed curable resin container.

13. The kit of claim 12 contained in a display card, including a blister cover, said integral resin chamber construction imprinted in said blister cover.
